(19) United States
(12) Patent Application Publication
(10) Pub. No.: US 2004/0139641 A1
(43) Pub. Date: Jul. 22, 2004

(54) Label holder assembly

(76) Inventors: Sean Coleman, Lees Summit, MO (US); Michael Bailey, Hollywood, FL (US); Rojas Ralph, Miami, FL (US)

Correspondence Address: JACOBSON HOLMAN PLLC, 400 SEVENTH STREET N.W., SUITE 600, WASHINGTON, DC, 20004, US

(21) Appl. No.: 10/685,391

(22) Filed: Oct. 16, 2003

Related U.S. Application Data
(60) Provisional application No. 60/431,722, filed on Dec. 9, 2002.

(51) Int. Cl. G09F 3/00; G09F 3/18

(52) U.S. Cl. 40/642.01; 40/642.02

(57) ABSTRACT

A label holder assembly for use with a prior art merchandise support hook which includes a hook back for attachment to a perforated board or the like and a forwardly and upwardly cantilevered merchandise support arm. The label holder assembly includes a label holder arm having a label holder at its distal end and a pair of depending legs at its proximal end adapted to be seated in a pair of spaced apertures in the hook back to support the label holder arm above, and generally at the same angle as, the merchandise support arm. The label holder may be a discrete element with a spring clip to secure the same to a cross bar at the distal end of the label holder arm.

This is a complete application claiming benefit of provisional application Serial No. 60/431,722 filed Dec. 9, 2002.

### BACKGROUND OF THE INVENTION

1. Field of the Invention

This invention relates to product identification and information display tags for merchandise suspended from horizontally extending support hooks and the like. More particularly, the invention relates to a label holder assembly adapted to cooperate with a commercially available merchandise-supporting hook assembly adapted to be carried by, and extend forwardly from, a perforated board or the like to receive and removably support various types of products.

2. Description of the Related Art

A range of product display tags are available for use with different types of support hooks. Oftentimes, the tags are die-cut from plastic sheet material to include a mounting portion which attaches at the rearward or proximal end of the hook, an elongate portion which extends forwardly over the support hook and the products suspended thereon, and a label holder for presenting product or inventory information at the forward or distal end of the support hook. Commonly, the product information is provided on a label adhesively secured to, or carried in a pocket formed by, a downwardly depending display portion of the tag at the distal end of the support hook so that the product information is conveniently displayed to a consumer or to store personnel forwardly of the merchandise.

Display tags of this type, while very inexpensive to manufacture, are generally made of thin sheets of plastic materials which tend to gather dust and over time may be distorted or damaged in use, requiring more frequent replacement. Thus, for certain applications more rigid or permanent label holder support devices may find favor.

One type of merchandise support hook assembly currently in use by certain merchandisers, including Radio Shack, includes a molded plastic hook back including a pair of rearwardly and upwardly extending ears or horns adapted to engage through the openings in a perforated board in a well known manner, and a generally vertically extending through opening to receive a downwardly extending rear leg of a generally forwardly extending merchandise support rod. With a hook of this nature, means must be provided for positioning a label holder forwardly of the front end of the hook in a relatively rigid manner to present product and inventory information forwardly of the merchandise to a consumer or to the merchandiser. Some prior art attempts to satisfy this problem have been unduly complicated, expensive to manufacture or have failed to be sufficiently robust to withstand the frequent impact to which the label holder assembly is commonly subjected in use.

### SUMMARY OF THE INVENTION

This invention, therefore, is directed to the provision of a label holder support assembly adapted to be easily engaged and disengaged from a hook back of the type described, while being inexpensive to manufacture, easy to use and sufficiently robust for long term, extended use.

Another object of this invention is to provide a label holder support assembly including a label holder support arm having a mounting portion at its rear end with a pair of spaced depending, pin-like, legs adapted to engage in complementary openings in the prior art hook back described above, with a cross bar at its forward end to snappingly receive resilient clip portions on the rear panel of a label holder.

A further object of this invention is to provide a mounting portion for a label holder wherein the legs are canted slightly rearwardly to cantilever the support arm generally parallel to, and spaced from, the forwardly and upwardly extending merchandise support hook, ensuring adequate space between the label holder support arm and the merchandise support hook to enable merchandise to be readily placed on the hook by the merchandiser and removed therefrom by the consumer.

Yet another object of this invention is to provide a label holder support assembly of the type described wherein the cross bar has a flattened forward face designed to cooperate with the rearward face of a label holder back panel to preclude undesirable tilting of the label holder which may distort the presentation of information on labels carried thereby.

Other and further objects, features and advantages of the invention will become apparent from the ensuing description and claims taken in conjunction with the attached drawings.

### BRIEF DESCRIPTION OF THE DRAWINGS

FIG. 1 is an exploded view, partially broken away for illustrative convenience, of a prior art merchandise support hook assembly carried by a perforated board;

FIG. 2 is a top plan view of the hook back of the merchandise support hook assembly of FIG. 1;

FIG. 3 is a front elevational view of the hook back;

FIG. 4 is a perspective view of the merchandise support hook assembly of FIG. 1 carrying a label holder support assembly according to this invention;

FIG. 5 is a perspective view of the elements of FIG. 4 from an opposite direction;

FIG. 6 is a perspective view of the label holder support arm of the label holder support assembly of this invention;

FIG. 7 is a top elevational view of the label holder support arm;

FIG. 8 is a side elevational view thereof; and

FIG. 9 is a front end elevational view thereof.

Like reference characters refer to like parts throughout the several views of the drawings.

### DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

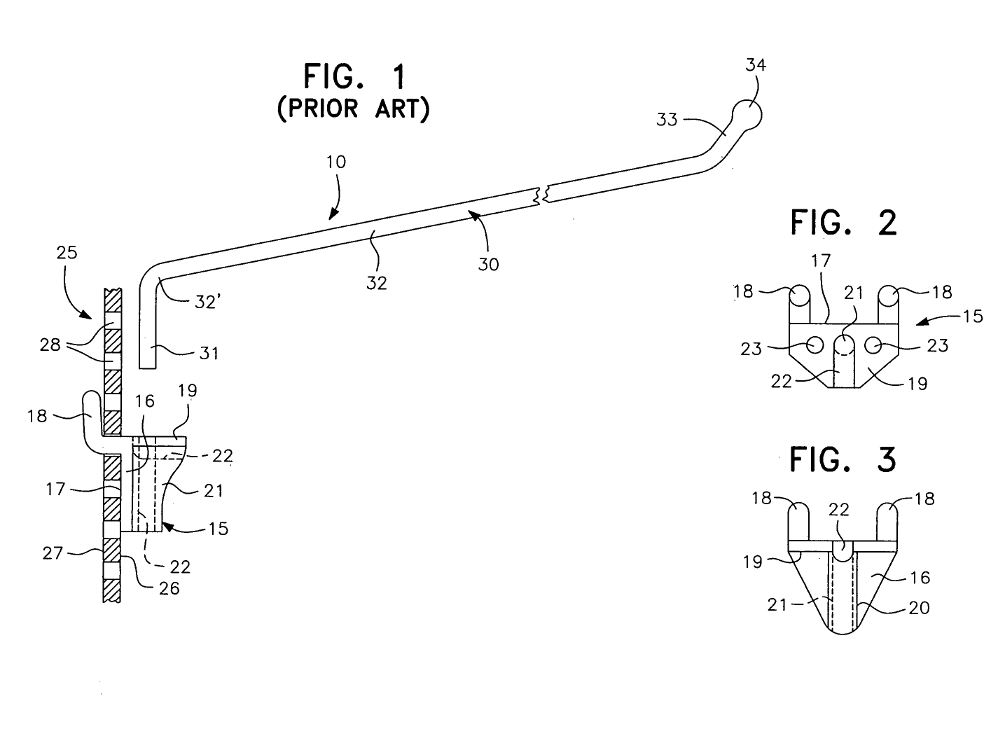

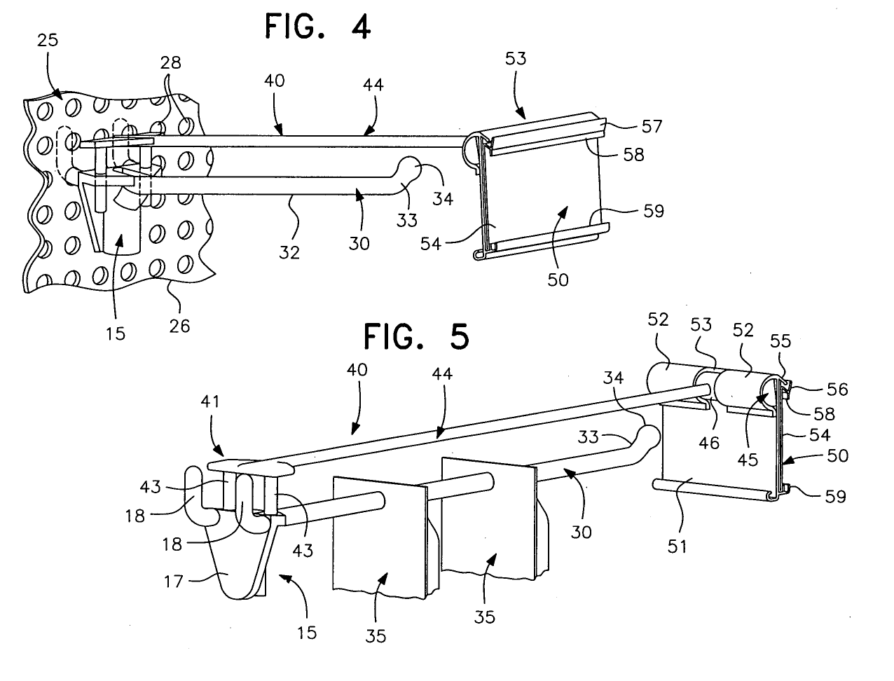

Referring now to the drawings, and more particularly to FIGS. 1-3, a commercially available prior art merchandise support hook assembly is designated generally by the reference numeral 10 and comprises a hook back 15 adapted to be secured to a perforated board 25 and to carry a forwardly extending hook element 30. The perforated board, also shown in FIG. 4, comprises, as is well known, a relatively thin board material having a front surface 26, a rear surface 27 and a plurality of through-apertures 28, generally on a square or rectangular pattern.

The hook back 15 of the merchandise support hook assembly 10 is commonly molded of any conventional plastic and includes a generally vertically extending planar rear web 16 with a flat back 17 from which a pair of ears or horns extend rearwardly and upwardly for engagement in a select pair of apertures 28 in the perforated board 25 as seen in FIGS. 1 and 4. A forwardly extending flange 19 is supported by a vertically extending central protuberance 20 having a vertically extending opening 21 defined therethrough, the upper end of which communicates with a forwardly extending, generally arcuate groove 22. Finally, a pair of apertures 23 are defined through the flange 19 on opposite sides of the opening 21.

The hook element 30 of the merchandise support hook assembly 10 is commonly formed of a metal rod having a depending leg 31 at its proximal end from which an elongated merchandise support 32 extends forwardly and upwardly, terminating with a hook 33 having a bulbous tip 34 adapted to preclude accidental disengagement of merchandise such as the apertured blister packages 35 illustratively shown in FIG. 5.

In use, with the horns 18 of the hook back 15 engaged through the apertures 28 of the perforated board 25, depending leg 31 of the hook element 30 is inserted in the opening 21 of the hook back 15 with the proximal end portion 32′ of the merchandise support 32 resting in the groove 22 in a well known manner. Merchandise, such as illustrated at 35, can be placed on, or removed from, the hook 30 by sliding the same over the tip 34.

The merchandise support hook assembly is not a part of the invention except to the extent that portions of the label holder support assembly are adapted to cooperate with portions of the merchandise support hook assembly. As will be recognized from the following disclosure, the label holder support assembly of this invention can be readily modified by those with ordinary skill in this art to cooperate with merchandise support hook assemblies of different configurations.

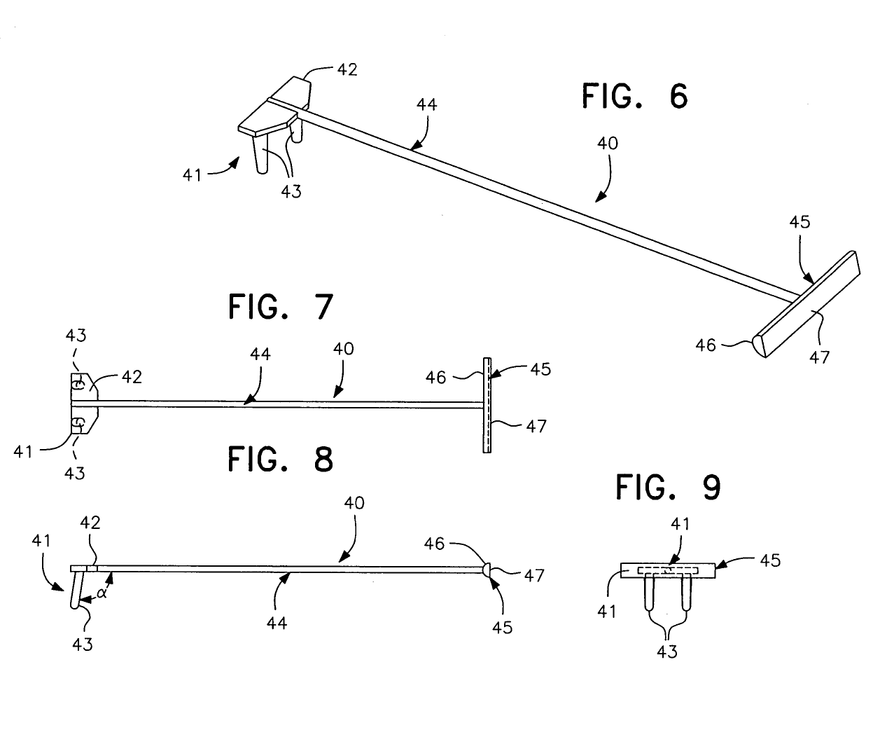

As mentioned above, the instant invention is directed to a means for supporting a label and/or sign forwardly of the tip 34 of the hook element 30 of the merchandise support hook assembly 10 to provide consumers and store personnel with identification and information regarding the merchandise 35 to be carried by the merchandise support 32. To that end, the label holder support assembly of this invention comprises two elements, a label holder support arm 40 shown in detail in FIGS. 6-9, and a label holder 50 adapted to cooperate therewith.

The label holder support arm 40 includes a mounting portion 41 at its proximal end comprising, in use, a generally horizontally extending flange 42 with a pair of spaced, downwardly depending, and slightly rearwardly inclined, legs 43. A forwardly extending rod 44 carries a transversely extending cross bar 45 at its distal end. Preferably, the cross bar 45 has an arcuate rear face 46 and a generally vertically extending, planar front face 47.

The legs 43 of the label holder support arm 40 are adapted for engagement in the apertures 23 of the hook back 15 as seen particularly in FIGS. 4 and 5. To approximate the slightly upwardly extending angle of the merchandise support 32 of the hook element 30, the legs 43 may be inclined slightly to the rear at an angle ∝ as seen in FIG. 8 of, perhaps 2°, so that, when the legs 43 are engaged in the apertures 23, the rod 44 will be inclined upwardly relative to the perforated board 25 at approximately the same angle as the merchandise support 32.

Additionally, the legs 43 may be tapered toward their lower extremity so that, when they are engaged in the apertures 23 of the hook back 15, they can only extend to a certain distance, the upper portions of the legs 43 being slightly larger than the size of the apertures 23 to automatically position the rod 44 in spaced, generally parallel, relation to the merchandise support 32 of the hook element 30. This ensures that adequate space is provided for the merchandise 35 to be readily received on, and removed from, the hook element 30.

Obviously, other stop mechanisms, such as a shoulder (not shown), may be molded or incorporated into the legs 43 to similarly space the rod 44 from the merchandise support 32.

The length of the label holder support arm 40 can be varied depending upon the length of the hook element 30 to ensure that the cross bar 45 extends beyond the tip 34 of the hook element 30 as seen in FIGS. 4 and 5.

The label holder 50 may take any conventional form and may be adapted for receipt of adhesive or non-adhesive paper or plastic labels and/or signs. A preferred form of extruded label holder 50 is shown in FIGS. 4 and 5 as comprising a generally opaque back panel 51 with a pair of arcuate clip elements 52 flexibly connected to the top of the back panel 51 for snapping engagement over the cross bar 45 of the label holder support arm 40 in an obvious manner. A notch or space 53 is provided between the clip elements 52 to accommodate the rod 44 of the label holder support arm 40.

For receiving non-adhesive labels, the label holder 50 may include a transparent cover 54 resiliently connected to the back panel 51 at its lower end to form a pocket therebetween in a well known manner.

Cooperating locking members 55, 56 may be provided at the top of the back panel 51 and the cover 54, respectively, with a finger-engaging element 57 extending upwardly and forwardly from the element 56 to facilitate opening the cover 54 to insert or remove labels (not shown) from the pocket formed between the back panel 51 and the cover 54. Such a construction is seen in U.S. Pat. No. 5,518,632, the subject matter of which is incorporated herein in its entirety by reference.

Additionally, if desired, the label holder 50 can include integral upper and lower sign holder channels 58, 59 so that a sign or sign holder (not shown) can be carried by the cover 54 to highlight special information regarding the merchandise 35 as seen in U.S. Pat. No. 6,568,112 issued May 27, 2003, the subject matter of which is also incorporated herein in its entirety by reference.

The details of the label holder 50 are not critical to the instant inventive concepts, merely the cooperation between the label holder 50 and the label holder support arm 40. In this respect, it is noted that the generally planar front face 47 of the cross bar 45 is adapted to engage the planar rear face of the back panel 51 of the label holder 50 to fixedly position the label holder 50 relative to the merchandise 35. By this planar-to-planar engagement, the label holder 50 is precluded from rotation on the cross bar 45 of the support label holder arm 40 minimizing the likelihood that the information carried on the labels supported by the label holder 50 will be angularly distorted when presented to consumers or store personnel attempting to read the same visually or electronically.

The use and operation of the label holder support assembly of this invention will now be readily understood. The label holder support arm 40 is engaged with the hook back 15 by inserting the legs 43 in the apertures 23 until they are stopped to position the rod 44 at an appropriate height above the merchandise support 32. The label holder 50 can then be snapped over the label holder support arm 45 and provided with informational labels in an obvious manner.

The foregoing descriptions and drawings should be considered as illustrative only of the principles of the invention. As noted, the invention may be configured in a variety of shapes and sizes and is not limited by the dimensions of the preferred embodiment. Numerous applications of the present invention will readily occur to those skilled in the art. Therefore, it is not desired to limit the invention to the preferred embodiments or the exact construction and operation shown and described. Rather, all suitable modifications and equivalents may be resorted to, falling within the scope of the invention.

What is claimed is:

1. For use in association with a merchandise support hook assembly comprising a hook back adapted to be attached to a supporting surface and a forwardly extending merchandise support hook, wherein the hook back includes a pair of spaced apertures extending generally vertically in use, the improvement which comprises a label holder assembly including a label holder arm having a proximal end and a distal end, a pair of spaced legs carried by said proximal end and adapted to be seated in apertures in the hook back to cantilever said label holder arm in spaced relationship over the merchandise support arm, and a label holder at said distal end of said label holder arm.

2. The improvement of claim 1 wherein said label holder arm is longer than the merchandise support hook.

3. The improvement of claim 1 wherein the support surface is a perforated board comprising a multiplicity of spaced through-apertures, and the hook back includes a pair of rearwardly and upwardly extending spaced ears adapted to be engaged through selected apertures in the perforated board.

4. The improvement of claim 1 wherein the hook back includes a central, generally vertically extending, opening and the merchandise support hook includes a downwardly depending leg at its proximal end adapted to be seated in the opening in the hook back to cantilever the merchandise support hook forwardly of the hook back.

5. The improvement of claim 4 wherein the hook back includes a forwardly extending flange, the merchandise support hook-receiving opening being defined centrally of the hook back flange, and the spaced apertures adapted to receive said spaced legs of said label holder assembly being defined through the flange on opposite sides of the opening.

6. The improvement of claim 5 wherein the merchandise support hook extends forwardly and upwardly from the hook back, and said spaced legs on said label holder are inclined rearwardly with respect to said label holder arm to cantilever said label holder arm forwardly and upwardly at an angle approximating the angle of the merchandise support hook.

7. The improvement of claim 1 further including stop means to cantilever said label holder arm in vertically spaced relationship to said merchandise support arm when said spaced legs are seated in the apertures in the hook back.

8. The improvement of claim 7 wherein the hook back includes a forwardly extending flange and the spaced apertures are defined therethrough, said spaced legs on said label holder having different thicknesses along their length, a first thickness being smaller in cross-section than the cross-section of the spaced apertures in the hook back and a second thickness closer to said label holder arm being greater in cross-section than at least one dimension of the spaced apertures in the hook back to limit the level to which the label holder arm can be seated in the spaced apertures of the hook back.

9. The improvement of claim 8 wherein said spaced legs on said label holder arm are tapered in cross-section.

10. The improvement of claim 1 wherein said label holder is a discrete element, and means on said distal end of said label holder arm to removably receive said label holder.

11. The improvement of claim 10 further including a cross bar fixed to said distal end of said label holder arm, and a spring clip carried by said label holder and adapted to be resiliently engaged over said cross bar.
clip carried by said label holder and adapted to be resiliently engaged over said cross bar.

12. The improvement of claim 10 wherein said label holder includes a body panel having an upper end and a lower end and generally planar front and rear faces, said spring clip being carried by said upper end of said body panel and extending rearwardly therefrom.

13. The improvement of claim 12 wherein said label holder further includes a transparent cover member having an upper end and a lower end and a front face and a rear face, said lower ends of said body panel and said cover member being resiliently connected to define a label-receiving pocket between said front face of said body panel and said rear face of said cover member.

14. The improvement of claim 12 wherein said cross bar includes a generally planar front face and an arcuate rear face, said spring clip being arcuate and engaged over said arcuate face of said cross bar in use, said planar front face of said cross bar engaging said planar rear face of said body panel to preclude rotation between said label holder and said cross bar.

15. In combination,
a merchandise support hook assembly, a supporting surface and a label holder assembly,
said merchandise support hook assembly comprising a hook back, means attaching said hook back to said supporting surface, and a forwardly extending merchandise support arm, said hook back including a pair of spaced apertures extending generally vertically in use,
said label holder assembly comprising a label holder arm having a proximal end and a distal end, a pair of spaced legs carried by said proximal end and seated in said apertures in said hook back to cantilever said label holder arm and support said label holder arm in spaced relationship over said merchandise support arm, and a label holder at said distal end of said label holder arm.

16. The combination of claim 15 wherein said label holder arm is longer than said merchandise support arm.

17. The combination of claim 15 wherein said supporting surface is a perforated board comprising a multiplicity of spaced through-apertures, and said hook back includes a pair of rearwardly and upwardly extending spaced ears engaged through selected apertures in said perforated board.

18. The combination of claim 15 wherein said hook back includes a central, generally vertically extending, opening and said merchandise support arm includes a downwardly depending leg at its proximal end seated in said opening in said hook back to cantilever said merchandise support hook forwardly of said hook back.

19. The combination of claim 18 wherein said hook back includes a forwardly extending flange, said merchandise support hook-receiving opening being defined centrally of said hook back flange, and said spaced apertures receiving said spaced legs of said label holder assembly being defined through said hook back flange on opposite sides of said opening.

20. The combination of claim 19 wherein said merchandise support arm extends forwardly and upwardly from the hook back, and said spaced legs on said label holder are inclined rearwardly with respect to said label holder arm to cantilever said label holder arm forwardly and upwardly at an angle approximating the angle of said merchandise support arm.

21. The combination of claim 15 further including stop means to position said label holder arm in vertically spaced relationship to said merchandise support arm when said spaced legs are seated in the spaced apertures in said hook back.

22. The improvement of claim 21 wherein said hook back includes a forwardly extending flange and said spaced apertures are defined therethrough, said spaced legs on said label holder assembly having different thicknesses along their length, a first thickness being smaller in cross-section than the cross-section of said spaced apertures in said hook back and a second thickness closer to said label holder arm being greater in cross-section than at least one dimension of said spaced apertures in said hook back to limit the level to which said spaced legs can be seated in said spaced apertures of said hook back.

23. The combination of claim 22 wherein said spaced legs on said label holder arm are tapered in cross-section.

24. The combination of claim 15 wherein said label holder is a discrete element, and means on said distal end of said label holder arm removably receiving said label holder.

25. The combination of claim 24 further including a cross bar fixed to said distal end of said label holder arm, and a spring clip carried by said label holder and resiliently engaged over said cross bar.

26. The combination of claim 24 wherein said label holder includes a body panel having an upper end and a lower end and generally planar front and rear faces, said spring clip being carried by said upper end of said body panel and extending rearwardly therefrom.

27. The combination of claim 26 wherein said label holder further includes a transparent cover member having an upper end and a lower end and a front face and a rear face, said lower ends of said body panel and said cover member being resiliently connected to define a label-receiving pocket between said front face of said body panel and said rear face of said cover member.

28. The combination of claim 26 wherein said cross bar includes a generally planar front face and an arcuate rear face, said spring clip being arcuate and engaged over said arcuate face of said cross bar, said planar front face of said cross bar engaging said planar rear face of said body panel to preclude rotation between said label holder and said cross bar.
